(19) United States
(12) Patent Application Publication
(10) Pub. No.: US 2025/0323257 A1
(43) Pub. Date: Oct. 16, 2025

(54) LITHIUM AND MANGANESE RICH POSITIVE ACTIVE MATERIAL COMPOSITIONS

(71) Applicant: FORD GLOBAL TECHNOLOGIES, LLC, Dearborn, MI (US)

(72) Inventors: Eunsung LEE, Novi, MI (US); Chi PAIK, Grosse Ile, MI (US); Jason Aaron LUPESCU, Wayne, MI (US); Yisun CHENG, Ann Arbor, MI (US); Robert J. KUDLA, Canton, MI (US); Deepali KOZAREKAR, Novi, MI (US); Mary FREDRICK, Carleton, MI (US); Patrick BONNICK, Ann Arbor, MI (US); Liyuan SUN, Ann Arbor, MI (US)

(21) Appl. No.: 18/631,984

(22) Filed: Apr. 10, 2024

(51) Int. Cl. H01M 4/525; H01M 4/02; H01M 4/505; H01M 10/0525; H01M 10/42

(52) U.S. Cl. CPC H01M 4/525; H01M 4/505; H01M 10/0525; H01M 10/4207; H01M 2004/028

(57) ABSTRACT

A positive electrode active material may include a compound represented by the formula Li_{1.04 to 1.06}Mn_{0.52 to 0.53}Ni_{0.41 to 0.44-x}MₓO₂, where M represents cobalt, chromium, or a combination thereof, and x ranges from 0 to 0.1. The average oxidation state of manganese is controlled between 3.8 and 4.0. The average oxidation state of nickel is controlled to be 2.0. A battery may contain the positive electrode.

### TECHNICAL FIELD

In at least one aspect, positive electrode active materials for lithium-ion batteries are provided.

### BACKGROUND

Lithium and Manganese Rich (LMR) positive electrode active material has been considered a promising next-generation cathode material due to its high gravimetric energy density compared to currently used Nickel Cobalt Manganese (NCM) and Nickel Cobalt Aluminum (NCA) materials.

### SUMMARY

In at least one aspect, a positive electrode active material is provided. The positive electrode active material includes a compound represented by the general formula 1: Li_{1.04 to 1.06}Mn_{0.52 to 0.53}Ni_{0.41 to 0.44-x}MₓO₂, wherein M is Co, Cr, or a combination thereof, and 0<x≤0.1. The positive electrode active material may have the average oxidation state of manganese controlled between 3.8 and 4.0. Further, the positive electrode active material may have the average oxidation state of nickel controlled to be exactly 2.0. When the lithium content is 1.04, the manganese content may be precisely 0.52, and the nickel content may follow the formula 0.44-x, where M includes cobalt, chromium, or a combination thereof, with 0<x≤0.1. When the lithium content is adjusted to 1.06, the manganese content may be set at 0.53, and the nickel content may adhere to the formula 0.41-x. Here again, M includes cobalt, chromium, or a combination thereof, with 0<x<0.1. The positive electrode active material may be incorporated into a cathode. The cathode containing the positive electrode active material may be combined with an anode and an electrolyte to form a lithium-ion battery.

In another aspect of the disclosure, a positive electrode for a lithium-ion battery is provided. The positive electrode includes a positive electrode active material with a compound represented by the general formula 1: Li_{1.04}Mn_{0.52}Ni_{0.44-x}MₓO₂, wherein M is Co, Cr, or a combination thereof, and 0<x≤0.1. The positive electrode may have the average oxidation state of manganese controlled between 3.8 and 4.0. Further, the positive electrode may have the average oxidation state of nickel controlled to be exactly 2.0. The positive electrode may be packed with a negative electrode and an electrolyte to form a lithium-ion battery.

In yet another aspect of the disclosure, a rechargeable lithium-ion battery with at least one lithium-ion battery cell is provided. Each lithium-ion battery cell includes a positive electrode comprising a positive electrode active material as represented by formula 1: Li_{1.06}Mn_{0.53}Ni_{0.41-x}MₓO₂, a negative electrode including a negative electrode active material, and an electrolyte, wherein M is Co, Cr, or a combination thereof, and 0<x<0.1. The rechargeable lithium-ion battery may have the positive electrode active material's average oxidation state of manganese controlled between 3.8 and 4.0 and the average oxidation state of nickel controlled to 2.0. The rechargeable lithium-ion battery may include a plurality of battery cells. The rechargeable lithium-ion battery may have the plurality of battery cells form a battery pack. The rechargeable lithium-ion battery may further include a separator interposed between the positive electrode and the negative electrode in each battery cell. The rechargeable lithium-ion battery may have each battery cell exhibit a cathode specific capacity greater than 200 mAh/g.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A is a schematic view, in cross-section, of a positive electrode that includes cathode active material on a single side of a current collector;

FIG. 1B is a schematic view, in cross-section, of a positive electrode that includes cathode active material on both sides of a current collector;

FIG. 2 is a schematic view, in cross-section, of a battery cell that includes the positive electrode of FIG. 1A; and

FIG. 3 is a schematic view, in cross-section, of a battery pack that includes the battery cells of FIG. 2.

### DETAILED DESCRIPTION

Reference will now be made in detail to presently preferred compositions, embodiments, and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Unless expressly stated to the contrary, when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It should be noted that, as used in the specification and the appended claims, the singular form “a,” “an,” and “the” comprise plural referents unless the context clearly indicates otherwise. For example, reference to a component in the singular is intended to comprise a plurality of components. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps. The phrase “composed of” means “including” or “consisting of.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1, the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The term “positive electrode” means a battery cell electrode from which current flows out when the lithium-ion battery cell or battery is discharged. Sometimes a “positive electrode” is referred to as a “cathode.” The term “negative electrode” means a battery cell electrode to which current flows in when the lithium-ion battery cell is discharged. Sometimes a “negative electrode” is referred to as an “anode.” The term “cell” or “battery cell” means an electrochemical cell made of at least one positive electrode, at least one negative electrode, an electrolyte, and a separator membrane. The term “battery” or “battery pack” means an electric storage device made of at least one battery cell. In a refinement, “battery” or “battery pack” is an electric storage device made of a plurality of battery cells. The term “specific capacity” means the capacity per unit mass of the active material. Specific capacity has units of milliamp hours/gram (mAh/g).

There are intrinsic issues with current LMR material compositions such as voltage decay during cycling, rate capability, cycle performance, and volumetric energy density. Accordingly, there is a need for optimized LMR material compositions for positive electrode active materials for lithium-ion batteries with increased rate capability, cell performance, and volumetric energy density.

The present disclosure provides compositions for Lithium Manganese Rich (LMR) cathodes used in lithium-ion batteries. The performance issues inherent to conventional LMR compositions may include voltage decay during cycling, decreased rate capability over successive cycles, and poor cycle performance. These issues can be mitigated by optimizing the composition of the LMR.

In one or more embodiments of this disclosure, the LMR compositions are optimized to have lower Li content (Li₂MnO₃) than conventional compositions. This modification betters the cycle performance, power performance, and rate capability by enhancing the voltage decay suppression, and electronic and ionic conductivity of the LMR. However, it is recognized that lower Li content typically results in lower capacity than conventional LMR.

To address this potential reduction in capacity, the LMR composition is further modified to incorporate increased Nickel (Ni) with optimized Manganese (Mn) or Chromium (Cr). This modified composition series increases capacity from Ni and Mn by controlling the average oxidation state of the Ni and Mn ions. Optimized Co content also contributes to electronic and ionic conductivity.

In one aspect of the disclosure, a general formula for a LMR composition is Li_{1.04 to 1.06}Mn_{0.52 to 0.53}Ni_{0.41 to 0.44-x}MₓO₂, where M is Co, Cr, or a combination thereof, and x ranges from 0 to 0.1. This formula allows for fine-tuning the material's properties to achieve specific performance goals based upon the intended application. Adjusting the lithium (Li) content within this range, alongside management of manganese (Mn) and nickel (Ni), and cobalt (Co) ratios, maintains a balanced approach to enhancing cycle performance, power efficiency, and rate capability.

In another aspect of the disclosure, the composition may be specified as Li_{1.04}Mn_{0.52}Ni_{0.44-x}MₓO₂ for certain applications requiring enhanced power efficiency and robust cycle performance. This variation features lowered Li and Mn contents, to support the battery's ability to undergo prolonged charge discharge cycles in more demanding conditions. Within this composition, M can be Co, Cr, or a combination thereof. When M includes Co, the formulation benefits from the high electronic conductivity attributed to Co, thereby optimizing the battery's performance. Similarly, the inclusion of Cr, known for its electrochemical stability, increases durability and operational efficiency. The variable x, maintained within the range of 0 to 0.1, to facilitate adjustments in the material's electrochemical properties, allowing for customization to meet the specific requirements of varied operational contexts. The average oxidation state of Mn is controlled between 3.8 and 4.0, and the average oxidation state of Ni is maintained at 2.0.

In yet another aspect, the composition may be Li_{1.06}Mn_{0.53}Ni_{0.41-x}MₓO₂, configured for applications that prioritize higher energy density and enhanced rate capability. This variation features increased Li and Mn contents, to support the battery's ability to show higher capacity. Within this composition, M represents Co, Cr, or a combination thereof. The inclusion of Co leverages its high electronic conductivity, optimizing the battery's performance, while the presence of Cr, known for its electrochemical stability, further improves the material's durability and operational efficiency. The variable x, chosen within the range of 0 to 0.1, allows for adjustments to the electrochemical characteristics of the material. This enables the formulation to be tuned to meet the specific performance demands of various applications. The average oxidation state of Mn is controlled between 3.8 and 4.0, for capacity and stability, while the average oxidation state of Ni is kept at 2.0, for maximizing the capacity contributions from Ni and enhancing the overall electrochemical performance of the material.

Incorporating this positive electrode active material into a cathode allows for its integration into lithium-ion batteries. This approach combines the cathode with an anode and electrolyte to form the battery, highlighting the practical application of the novel material in producing batteries with superior performance metrics. A rechargeable lithium-ion battery incorporating this LMR composition may have a specific capacity greater than 200 mAh/g. This capacity achievement underscores the potential for increased energy density and efficiency across various applications.

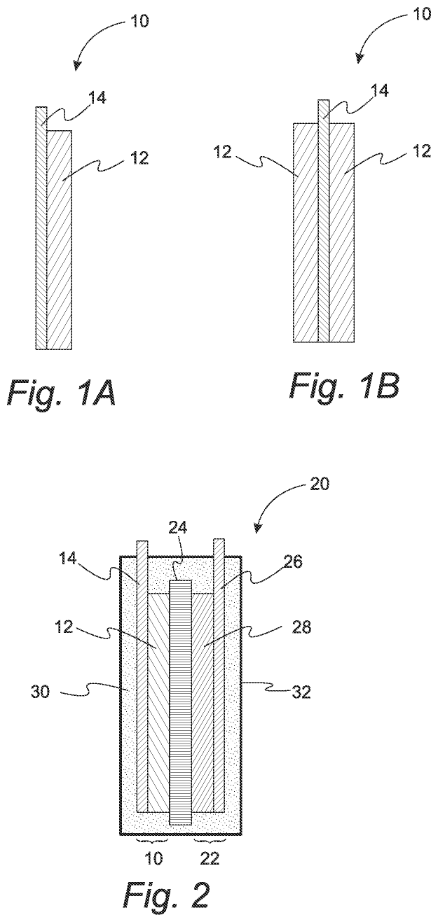

Referring to FIG. 1, a schematic of a positive electrode that includes a positive electrode active material is provided. Positive electrode 10 includes positive electrode active material layer 12 of positive electrode active material disposed over and typically contacting positive electrode current collector 14. Typically, the positive electrode current collector 14 is a metal plate or metal foil composed of a metal such as aluminum, copper, platinum, zinc, titanium, and the like. Currently, aluminum is most commonly used for the positive electrode current collector. The positive electrode active material is represented by formula 1:

Li_{1.04 to 1.06}Mn_{0.52 to 0.53}Ni_{0.41 to 0.44-x}MₓO₂ (1)
wherein:
M is Co, Cr, or a combination thereof; and
0<x≤0.1.

A specific active electrode composition is Li_{1.04}Mn_{0.52}Ni_{0.44-x}MₓO₂ for applications requiring enhanced power efficiency and robust cycle performance. In this formulation, M represents either Co, Cr, or a combination thereof, facilitating adjustments in the material's electrochemical properties to meet varied operational demands. The average oxidation state of the Ni ion is controlled to be 2.0, optimizing the capacity contributions from Ni. Similarly, the average oxidation state of Mn is maintained between 3.8 and 4.0, for balance between capacity, stability, and overall performance. The choice of x within the range of 0 to 0.1 allows for the tuning of the composition.

In another formulation, a specific active electrode composition is Li_{1.06}Mn_{0.53}Ni_{0.41-x}MₓO₂, for applications valuing higher energy density. This variant incorporates slightly higher contents of Li and Mn, to bolster the battery's capacity. M, encompassing Co, Cr, or their combinations, may bolster the structural stability and electrochemical performance of the material. The variable x, set within the 0 to 0.1 range, modulates the composition to optimize performance according to specific needs. The average oxidation state of Mn is controlled between 3.8 and 4.0, and it is maintained at 2.0 for Ni, maximizing the material's electrochemical efficacy and stability. The specific active electrode compositions detailed may be incorporated into a cathode. The cathode may be further packed with an and an electrolyte to form a lithium-ion battery.

With reference to FIG. 2, a schematic of a rechargeable lithium-ion battery cell incorporating the positive electrode of FIG. 1 is provided. Battery cell 20 includes the positive electrode 10 as described above, negative electrode 22, and separator 24 interposed between the positive electrode 10 and the negative electrode 22. The negative electrode 22 includes a negative electrode current collector 26 and a negative active material layer 28 disposed over and typically contacting the negative electrode current collector 26. Typically, the negative electrode current collector 26 is a metal plate or metal foil composed of a metal such as aluminum, copper, platinum, zinc, titanium, and the like. Currently, copper is most commonly used for the negative electrode current collector 26. The battery cell 20 is immersed in electrolyte 30 which is enclosed by battery cell case 32. The electrolyte 30 imbibes into the separator 24. In other words, the separator 24 includes the electrolyte thereby allowing lithium ions to move between the negative and positive electrodes. The electrolyte 30 includes a non-aqueous organic solvent and a lithium salt. The non-aqueous organic solvent serves as a medium for transmitting ions taking part in the electrochemical reaction of a battery. Advantageously, the battery cell 20 can have a specific capacity of greater than 200 mAh/g.

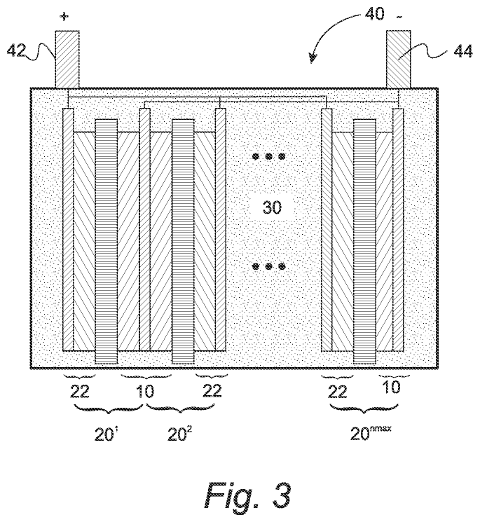

With reference to FIG. 3, a schematic of a rechargeable lithium-ion battery incorporating the positive electrode of FIG. 1 and the battery cells of FIG. 2 is provided. Rechargeable lithium-ion battery 40 includes at least one battery cell of the design in FIG. 2. Typically, the rechargeable lithium-ion battery 40 includes at least one battery cell 201 of the design of FIG. 2. Each of the lithium-ion battery cells 201 includes the positive electrode 10 which includes the compound represented by formula 1, the negative electrode 22 which includes a negative active material, and the electrolyte 30, where i is an integer label for each battery cell. The label i runs from 1 to nmax, where nmax is the total number of battery cells in the rechargeable lithium-ion battery 40. The electrolyte 30 includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from the battery 40 is provided across terminals 42 and 44. Advantageously, the rechargeable lithium-ion battery 40 can have a specific capacity of greater than 200 mAh/g for each battery cell therein.

Referring to FIGS. 2 and 3, the separator 24 physically separates the negative electrode 22 from the positive electrode 10 thereby preventing shorting while allowing the transport of lithium ions for charging and discharging. Therefore, the separator 24 can be composed of any material suitable for this purpose. Examples of suitable materials from which the separator 24 can be composed include but are not limited to, polytetrafluoroethylene (e.g., TEFLON®), glass fiber, polyester, polyethylene, polypropylene, and combinations thereof. The separator 24 can be in the form of either a woven or non-woven fabric. The separator 24 can be in the form of a non-woven fabric or a woven fabric. For example, a polyolefin-based polymer separator such as polyethylene and/or polypropylene is typically used for a lithium-ion battery. To ensure heat resistance or mechanical strength, a coated separator includes a coating of ceramic, or a polymer material may be used.

Referring to FIGS. 2 and 3, the electrolyte 30 includes a lithium salt dissolved in the non-aqueous organic solvent. Therefore, the electrolyte 30 includes lithium ions that can intercalate into the positive electrode active material during discharging and into the anode active material during charging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O4)₂, and combinations thereof. In a refinement, the electrolyte includes the lithium salt in an amount from about 0.1 M to about 2.0 M.

Still referring to FIGS. 2 and 3, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvents include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, the electrolyte 30 can further include vinylene carbonate or an ethylene carbonate-based compound to increase battery cycle life.

Referring to FIGS. 1, 2, and 3, the negative electrode and the positive electrode can be fabricated by methods known to those skilled in the art of lithium-ion batteries. Typically, an active material (e.g., the positive or negative active material) is mixed with a conductive material, and a binder in a solvent (e.g., N-methylpyrrolidone) is mixed into an active material composition and coated on the current collector. The electrode manufacturing method is well known and thus is not described in detail in the present specification. The solvent includes N-methylpyrrolidone and the like but is not limited thereto.

Referring to FIGS. 1, 2, and 3, the positive electrode active material layer 12 includes the positive electrode active material represented by formula 1, a binder, and a conductive material. The binder can increase the binding properties of positive electrode active material particles with one another and with the positive electrode current collector 14. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides the positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active material layer 26 includes a negative active material, a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials or silicon-based negative active materials can also be used for the negative active material.

The negative electrode binder increases the binding properties of negative active material particles with one another and with a current collector. The binder can be a non-aqueous binder, an aqueous binder, or a combination thereof. Examples of non-aqueous binders may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol, and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A positive electrode active material for lithium-ion batteries, comprising a compound represented by a general formula 1:
Li_{1.04 to 1.06}Mn_{0.52 to 0.53}Ni_{0.41 to 0.44-x}MₓO₂ (1)
wherein:
M is Co, Cr, or a combination thereof; and
0<x≤0.1.

2. The positive electrode active material of claim 1 wherein an average oxidation state of Mn is between 3.8 and 4.0.

3. The positive electrode active material of claim 1 wherein an average oxidation state of Ni is 2.0.

4. The positive electrode active material of claim 1 wherein when a Li content is 1.04, a Mn content is 0.52, and a Ni content is represented by a formula 0.44-x, where M is Co, Cr, or a combination thereof, and 0<x≤0.1.

5. The positive electrode active material of claim 1 wherein when the Li content is 1.06, a Mn content is 0.53, and a Ni content is represented by a formula 0.41-x, where M is Co, Cr, or a combination thereof, and 0<x<0.1.

6. The positive electrode active material of claim 1 wherein the active material is included in a cathode.

7. The positive electrode active material of claim 6 wherein the cathode is packed with an anode and an electrolyte to form a lithium-ion battery.

8. A positive electrode for a lithium-ion battery, the positive electrode comprising a positive electrode active material comprising a compound represented by chemical formula 1:
Li_{1.04 to 1.06}Mn_{0.52 to 0.53}Ni_{0.41 to 0.44-x}MₓO₂ (1)
wherein:
M is Co, Cr, or a combination thereof; and
0<x≤0.1.

9. The positive electrode of claim 8 wherein an average oxidation state of Mn is between 3.8 and 4.0.

10. The positive electrode of claim 8 wherein an average oxidation state of Ni is 2.0.

11. The positive electrode of claim 8 wherein the positive electrode is packed with a negative electrode and an electrolyte to form a lithium-ion battery.

12. A rechargeable lithium-ion battery comprising at least one lithium-ion battery cell, each lithium-ion battery cell including:
a positive electrode comprising a positive electrode active material as represented by formula 1:
Li_{1.04 to 1.06}Mn_{0.52 to 0.53}Ni_{0.41 to 0.44-x}MₓO₂ (1)
wherein:
M is Co, Cr, or a combination thereof;
0<x<0.1;
a negative electrode including a negative active material; and
an electrolyte.

13. The rechargeable lithium-ion battery of claim 12, wherein the Mn in the positive electrode active material has an average oxidation state of between 3.8 and 4.0.

14. The rechargeable lithium-ion battery of claim 12, wherein the Ni in the positive electrode active material has an average oxidation state of 2.0.

15. The rechargeable lithium-ion battery of claim 12 wherein the at least one lithium-ion battery cell is a plurality of battery cells.

16. The rechargeable lithium-ion battery of claim 15 wherein the plurality of battery cells forms a battery pack.

17. The rechargeable lithium-ion battery of claim 12 wherein each of the lithium-ion battery cells further includes a separator interposed between the positive electrode and the negative electrode.

18. The rechargeable lithium-ion battery of claim 12 wherein each of the lithium-ion battery cells has a specific capacity greater than 200 mAh/g.
